(19) United States
(12) Patent Application Publication
(10) Pub. No.: US 2022/0139035 A1
(43) Pub. Date: May 5, 2022

(54) GENERATION METHOD, COMPUTER-READABLE RECORDING MEDIUM STORING GENERATION PROGRAM, AND INFORMATION PROCESSING APPARATUS

(71) Applicant: FUJITSU LIMITED, Kawasaki-shi (JP)

(72) Inventors: Issei Inoue, Sumida (JP); Hiroshi Ikeda, Kawasaki (JP); Sho KUJIRAI, Kawasaki (JP)

(73) Assignee: FUJITSU LIMITED, Kawasaki-shi (JP)

(21) Appl. No.: 17/577,619

(22) Filed: Jan. 18, 2022

Related U.S. Application Data
(63) Continuation of application No. PCT/JP2019/028905, filed on Jul. 23, 2019.

(51) Int. Cl. G06T 17/10; G06V 40/10

(52) U.S. Cl. CPC G06T 17/10; G06V 40/103

(57) ABSTRACT

A generation method includes acquiring three-dimensional point group data on a surface of a subject from a measurement result of a sensor that obtains three-dimensional position information, determining a posture of a cylindrical model expressing each part of a human body with a plurality of cylinders based on the three-dimensional point group data, repeatedly executing processing of changing at least one of parameters for a length of the cylinder, a thickness of the cylinder, and an angle between an axis of the cylinder and an axis of an adjacent cylinder, of the plurality of cylinders and calculating a value of an evaluation function used to evaluate a matching degree between the cylindrical model and the three-dimensional point group data until the value satisfies a condition, generating a cylindrical model when the value satisfies the predetermined condition, and storing the cylindrical model in association with information used to identify the subject.

### CROSS-REFERENCE TO RELATED APPLICATION

This application is a continuation application of International Application PCT/JP2019/028905 filed on Jul. 23, 2019 and designated the U.S., the entire contents of which are incorporated herein by reference.

### FIELD

The embodiment discussed herein is related to a generation method or the like.

### BACKGROUND

In recent years, a skeleton of an athlete is recognized (determine each joint position of athlete) and a 3D model obtained from the joint positions over time is displayed, so that competition scoring is assisted or training is assisted. As one of the methods of skeleton recognition, a method is known for combining body shape information that models a body shape of an athlete with point group data obtained from a measurement result of a depth sensor and estimating a position of each joint of the athlete. Because accuracy of the skeleton recognition according to this method depends on how the body shape information reflects the body shape of the athlete, a technique is required that accurately measures the body shape of the athlete.

Here, a skeleton recognition technique using a shape completion and animation of people (SCAPE) model and a technique for generating the SCAPE model to be used have been known. Furthermore, there is another related art that generates a cylindrical model, which expresses each part of a human body as a cylinder, as body shape information. In the another related art, depth image information of a person is input to a random forest, and a part of the human body is distinguished, and the cylindrical model is adjusted.

A. Weiss et al., “Home 3D Body Scans from Noisy Image and Range Data”, IEEE ICCV, pp. 1951 to 1958 (2011), Q. Wang et al., “Im2Fit Fast 3D Model Fitting and Anthropometrics using Single Consumer Depth Camera and Synthetic Data”, 3DIPM-045.1-7, (2016), X. Wei et al., “Accurate Realtime Full-body Motion Capture Using a Single Depth Camera”, ACM Transactions on Graphics, Vol. 31, No. 6, Article 188 (2012), and D. Anguelov et al. (Stanford Univ), “SCAPE:Shape Completion and Animation of People”, ACM Transactions on Graphics, vol. 24, no. 3, pp. 408 to 416 (2005) are disclosed as related art.

### SUMMARY

According to an aspect of the embodiments, a generation method performed by a computer, the generation method includes acquiring three-dimensional point group data on a surface of a subject from a measurement result of a sensor that obtains three-dimensional position information of the subject; determining a posture of a cylindrical model that expresses each part of a human body with a plurality of cylinders based on the three-dimensional point group data; repeatedly executing processing of changing at least one of parameters among parameters for a length of the cylinder, a thickness of the cylinder, and an angle between an axis of the cylinder and an axis of an adjacent cylinder, of the plurality of cylinders and calculating a value of an evaluation function used to evaluate a matching degree between the cylindrical model of which the parameter is changed and the three-dimensional point group data until the value of the evaluation function satisfies a predetermined condition; generating a cylindrical model including the parameter when the value of the evaluation function satisfies the predetermined condition; and storing the cylindrical model in association with information used to identify the subject.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining processing of an information processing apparatus according to the present embodiment;

FIG. 2 is a diagram illustrating an example of a system according to the present embodiment;

FIG. 3 is a functional block diagram illustrating a structure of the information processing apparatus according to the present embodiment;

FIG. 4 is a diagram illustrating an example of a data structure of cylindrical model data;

FIG. 5 is a diagram illustrating a correspondence relationship between a cylinder and part identification information;

FIG. 6 is a diagram illustrating an example of a parameter of a cylinder;

FIG. 7 is a diagram illustrating an example of a data structure of a depth image table;

FIG. 8 is a diagram illustrating an example of a data structure of a cylindrical model data table;

FIG. 9 is a flowchart illustrating a processing procedure of the information processing apparatus according to the present embodiment;

FIG. 10 is a flowchart illustrating a processing procedure of generation processing according to the present embodiment; and

FIG. 11 is a diagram illustrating an example of a hardware structure of a computer that implements functions similar to those of the information processing apparatus.

### DESCRIPTION OF EMBODIMENTS

Because the SCAPE model is body shape information that defines the body to the body surface in detail, in the related art, there has been a problem in that processing for generating body shape information unique to an athlete and processing for estimating a skeleton position using the body shape information need time. On the other hand, the skeleton recognition technique using the cylindrical model can shorten a time required to generate the body shape information.

However, the related art using a cylindrical model has a problem in that it is not possible to accuracy obtain body shape information of a subject when the body shape information is expressed by the cylindrical model.

The embodiment has been made in consideration of the above, and an object of the present embodiment is to provide a generation method, a generation program, and an information processing apparatus that can obtain body shape information of a subject when the body shape information is expressed by a cylindrical model with higher accuracy than in the past.

Hereinafter, embodiments of a generation method, a generation program, and an information processing apparatus according to the present disclosure will be described in detail with reference to the drawings. Note that, the embodiments are not limited to the present disclosure.

### Embodiment

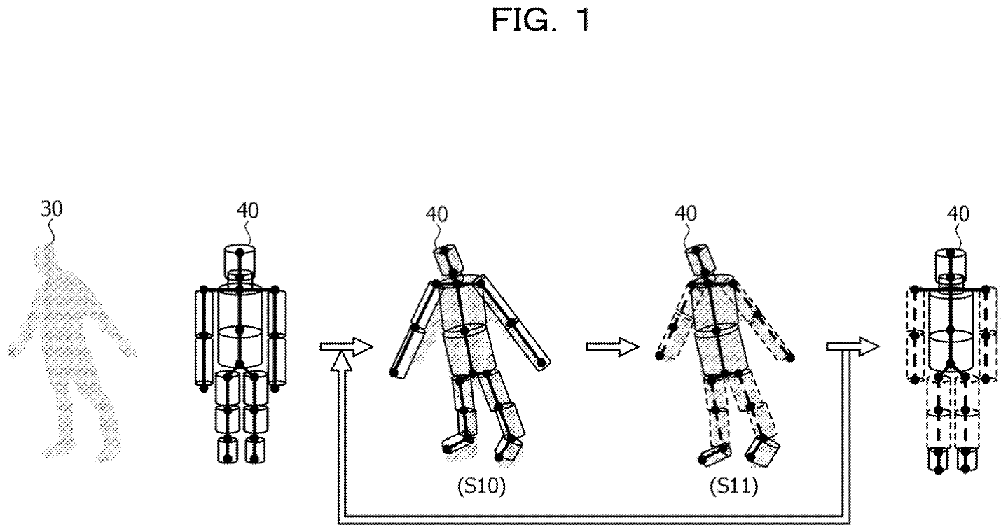

FIG. 1 is a diagram for explaining processing of an information processing apparatus according to the present embodiment. The information processing apparatus accepts inputs of point group data 30 and cylindrical model data 40. The point group data 30 is information indicating a three-dimensional position of each point on a surface of a subject obtained from measurement results of one or more depth sensors. The point group data 30 corresponds to “three-dimensional point group data”.

The cylindrical model data 40 is data of a model that expresses a part of the subject with a cylinder (or elliptical pillar or the like). In the following description, a cylinder or an elliptical pillar or the like are collectively referred to as a cylinder. An initial value of a parameter of each cylinder included in the cylindrical model data 40 is set to a value according to a body shape of a standard person. The parameters of the cylinder correspond to a height, a radius, a major radius, a minor radius, or the like of a cylinder.

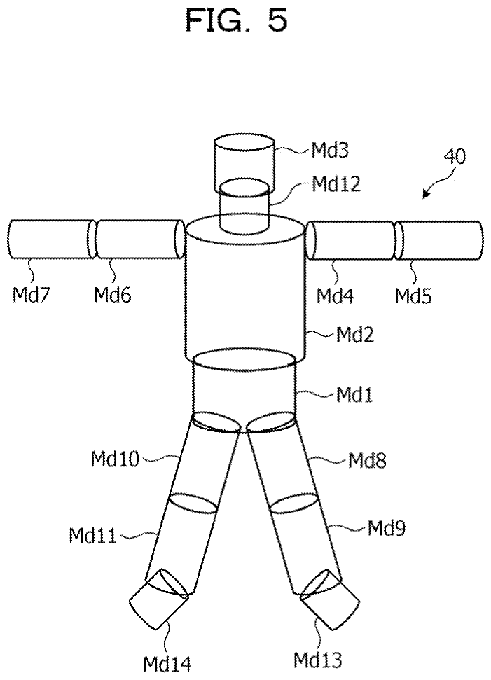

The information processing apparatus adjusts a posture of the cylindrical model data 40 so as to match the point group data 30 (step S10). The posture of the cylindrical model data 40 is defined by an angle θ between an axis of a cylinder of the cylindrical model data 40 with an axis of an adjacent cylinder, a three-dimensional position A of a cylinder end of a specific part (connection part between Md1 and Md2 (for example, waist) or the like), and a rotation angle δ with respect to a preset reference axis (three-dimensional rotation angle representing direction of Md1). The information processing apparatus adjusts the posture by changing each of angle θ, the three-dimensional position A, and the rotation angle δ of the cylindrical model data 40. Note that, Md1 and Md2 will be described later with reference to FIG. 5.

In step S10, the information processing apparatus adjusts the posture of the cylindrical model data 40, and then, adjusts the parameters of each cylinder of the cylindrical model data 40 so as to match the point group data 30 (step S11). The information processing apparatus repeatedly executes the processing in steps S10 and S11 until a solution of an evaluation function that evaluates a matching degree between the cylindrical model data 40 adjusted in steps S10 and S11 and the point group data 30 reaches an optimum solution.

In a case where the solution of the evaluation function reaches the optimum solution, the information processing apparatus saves the cylindrical model data 40 having the parameter of the cylinder when the solution reaches the optimum solution in a storage unit as body shape information.

As described above, the information processing apparatus according to the present embodiment searches for the parameters of the cylindrical model data 40 of which the value of the evaluation function reaches the optimum solution on the basis of the point group data 30 and the cylindrical model data 40 and generates body shape information of a subject expressed by the cylindrical model data 40. Because the number of parameters to be adjusted of the cylindrical model data 40 is less than an SCAPE model, it is possible to reduce a time required for searching for the parameter. Furthermore, a processing time for skeleton recognition using the generated body shape information can be shortened. Furthermore, each cylinder of the cylindrical model data 40 corresponds to each part of the subject, and the parameter of the cylinder is adjusted on the basis of the point group data 30 that defines the three-dimensional position of each point. Therefore, it is possible to obtain the body shape information of the subject with higher accuracy than a typical random forest method.

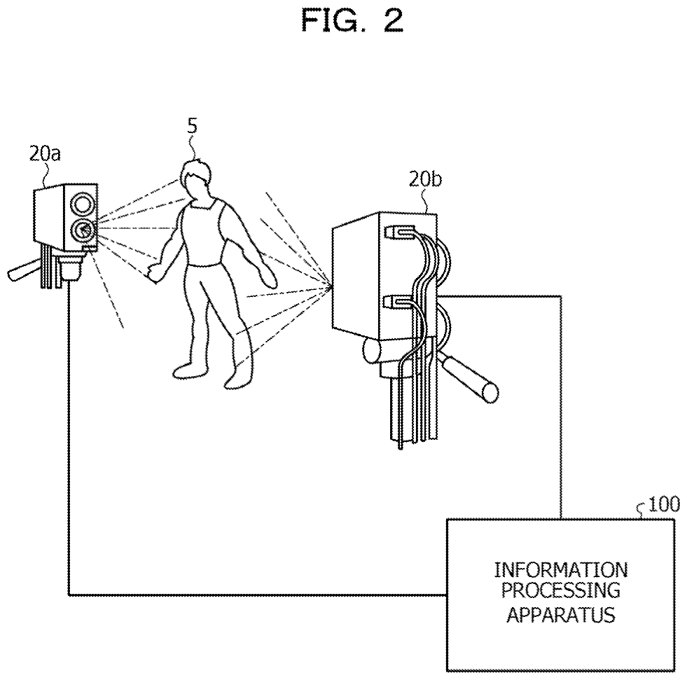

Next, an example of a system according to the present embodiment will be described. FIG. 2 is a diagram illustrating an example of the system according to the present embodiment. As illustrated in FIG. 2, this system includes depth sensors 20a and 20b and an information processing apparatus 100. The depth sensors 20a and 20b are connected to the information processing apparatus 100 through wireless or wired communication.

The depth sensors 20a and 20b are sensors that generate a depth image by measuring a distance to a subject 5. For example, the depth sensors 20a and 20b are provided on the front side and rear side of the subject 5. The depth sensors 20a and 20b output information regarding the depth image to the information processing apparatus 100. The depth image of the depth sensor 20a is information indicating each distance between each point on the subject 5 and the depth sensor 20a. The depth image of the depth sensor 20b is information indicating each distance between each point on the subject 5 and the depth sensor 20b.

Note that, at the time of measurement by the depth sensor, the subject 5 takes a plurality of postures (pose) instructed in advance and maintains the posture for a predetermined time at each posture. Each of the depth sensors 20a and 20b generates the depth image of each posture regarding the subject 5 and outputs the generated depth image to the information processing apparatus 100.

In the example illustrated in FIG. 2, the depth sensors 20a and 20b are illustrated. However, a depth image may be generated using still another depth sensor, or the number of depth sensors 20a may be one. In the following description, the depth sensors 20a and 20b are collectively referred to as a depth sensor 20. The information regarding the depth image is referred to as depth image information. In the depth image information, depth sensor identification information used to uniquely identify the depth sensor 20 that has generated the depth image information is set.

The information processing apparatus 100 calculates the point group data 30 of the subject 5 based on the depth image information acquired from the depth sensor 20. The information processing apparatus 100 searches for parameters of the cylindrical model data 40 of which the value of the evaluation function reaches the optimum solution on the basis of the point group data 30 and the cylindrical model data 40, generates body shape information of the subject 5 expressed by the cylindrical model data 40, and saves the body shape information in association with information used to identify the subject 5. The body shape information generated by the information processing apparatus 100 is used, for example, for skeleton recognition processing. The recognized skeleton (position of each joint) is used, for example, for competition scoring assistance or training assistance.

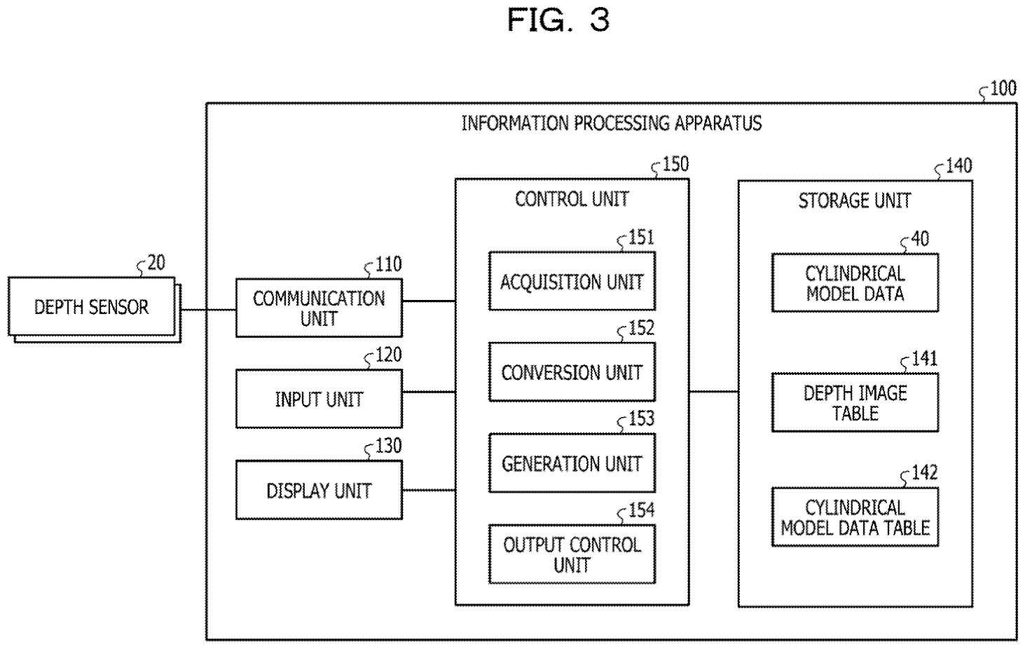

FIG. 3 is a functional block diagram illustrating a structure of the information processing apparatus according to the present embodiment. As illustrated in FIG. 3, this information processing apparatus 100 includes the depth sensor 20, a communication unit 110, an input unit 120, a display unit 130, a storage unit 140, and a control unit 150. Furthermore, the communication unit 110 is wirelessly or wiredly connected to the depth sensor 20.

The depth sensor 20 corresponds to the depth sensors 20a and 20b described with reference to FIG. 2. The depth sensor 20 is a sensor that generates the depth image information by measuring a distance to the subject 5. The depth sensor 20 outputs the depth image information to the communication unit 110.

The communication unit 110 is a processing unit that performs data communication with an external device such as the depth sensor 20 via a network. The control unit 150 to be described later exchanges data with an external device via the communication unit 110. The communication unit 110 is an example of a communication device.

The input unit 120 is an input device used to input various types of information to the information processing apparatus 100. The input unit 120 corresponds to a keyboard, a mouse, a touch panel, and the like.

The display unit 130 is a display device that displays information output from the control unit 150. The display unit 130 corresponds to a liquid crystal display, a touch panel, and the like.

The storage unit 140 includes the cylindrical model data 40, a depth image table 141, and a cylindrical model data table 142. The storage unit 140 corresponds to a semiconductor memory element such as a random access memory (RAM), a read-only memory (ROM), or a flash memory, or a storage device such as a hard disk drive (HDD).

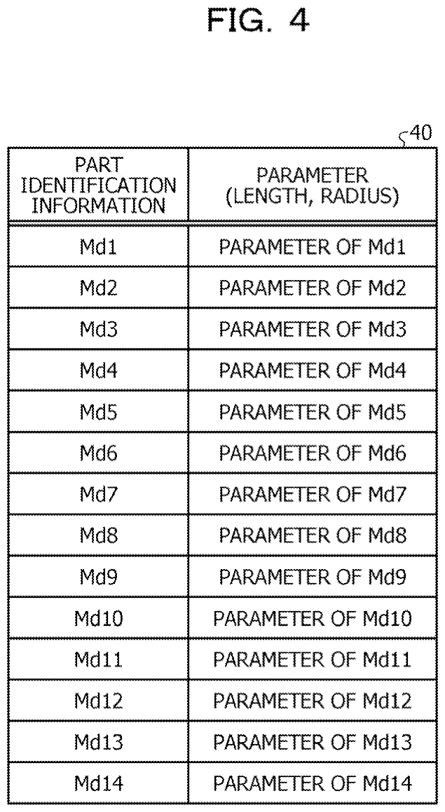

The cylindrical model data 40 is data of a model that expresses a part of the subject with a cylinder. FIG. 4 is a diagram illustrating an example of a data structure of cylindrical model data. As illustrated in FIG. 4, the cylindrical model data 40 associates part identification information with a parameter. The part identification information is information used to identify each cylinder included in a cylindrical model. The parameter indicates a parameter of a cylinder identified by the part identification information. The parameters of the cylinder include a length of the cylinder, a radius of the cylinder, or the like.

FIG. 5 is a diagram illustrating a correspondence relationship between a cylinder and part identification information. As illustrated in FIG. 5, respective pieces of part identification information Md1 to Md14 are associated with respective parts of the cylindrical model data 40, respectively. The pieces of part identification information Md1 to Md14 illustrated in FIG. 4 respectively correspond to the pieces of part identification information Md1 to Md14 illustrated in FIG. 5.

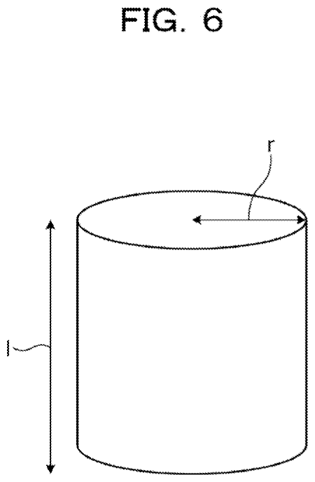

FIG. 6 is a diagram illustrating an example of a parameter of a cylinder. In FIG. 6, one of the plurality of cylinders Md1 to Md11 is illustrated. The parameters of the cylinder include a height I of the cylinder and a radius r of the cylinder. The radius r of the cylinder corresponds to a thickness of the cylinder. Note that, in the present embodiment, by adjusting these parameters, the body shape information of each subject can be accurately generated.

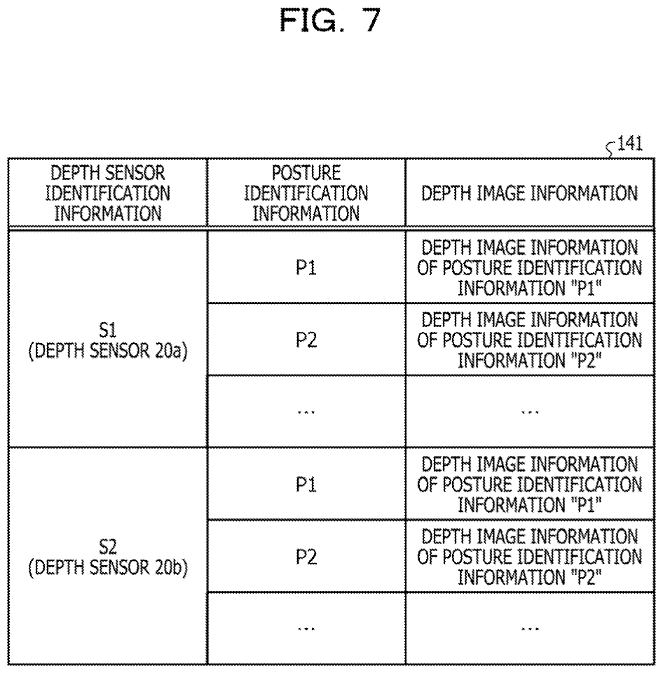

The depth image table 141 is a table that holds the depth image information generated by the depth sensor 20. FIG. 7 is a diagram illustrating an example of a data structure of a depth image table. As illustrated in FIG. 7, the depth image table 141 associates depth sensor identification information, posture identification information, and depth image information. The depth sensor identification information is information used to uniquely identify a depth sensor. For example, depth sensor identification information “S1” corresponds to the depth sensor 20a. Depth sensor identification information “S2” corresponds to the depth sensor 20b.

The posture identification information is information used to uniquely identify the posture of the subject 5. The depth image information is the depth image information generated by the depth sensor 20. As illustrated in FIG. 7, it is assumed that the depth sensor 20 generate the depth image information for each posture.

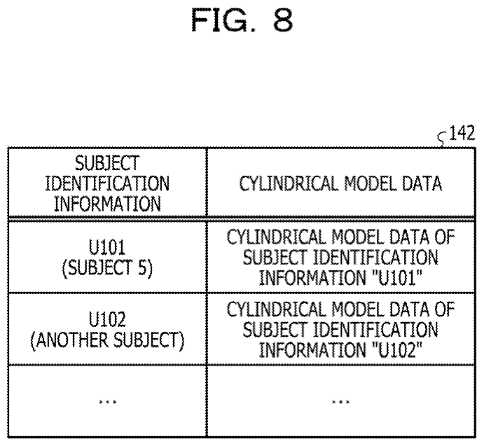

The cylindrical model data table 142 is a table that holds cylindrical model data of the subject 5 and other subjects. FIG. 8 is a diagram illustrating an example of a data structure of a cylindrical model data table. That is, for example, the cylindrical model data table 142 holds the cylindrical model data that is the body shape information for each subject. As illustrated in FIG. 8, the cylindrical model data table 142 associates subject identification information with cylindrical model data. The subject identification information is information used to uniquely identify a subject. The cylindrical model data is cylindrical model data corresponding to the subject.

The description returns to FIG. 3. The control unit 150 includes an acquisition unit 151, a conversion unit 152, a generation unit 153, and an output control unit 154. The control unit 150 can be implemented by a central processing unit (CPU), a micro processing unit (MPU), or the like. Furthermore, the control unit 150 may also be implemented by a hard wired logic such as an application specific integrated circuit (ASIC) or a field programmable gate array (FPGA).

The acquisition unit 151 is a processing unit that acquires various types of information and stores the acquired information in the storage unit 140.

In a case of acquiring the depth image information from the depth sensor 20, the acquisition unit 151 associates the depth sensor identification information, the posture identification information, and the depth image information and registers the associated information to the depth image table 141. Information indicating which posture identification information is associated with the depth image information acquired from the depth sensor 20 may be input and instructed by a user via the input unit 120, or the posture identification information may be acquired from a posture determination device that determines a posture of a target.

For example, the acquisition unit 151 associates the depth image information acquired from the depth sensor 20 with the posture identification information “P1” from a timing when the input of the posture identification information “P1” is accepted from the input unit 120 to a time after a predetermined period of time.

The conversion unit 152 is a processing unit that converts the depth image information into point group data.

An example of processing for converting the depth image information into the point group data by the conversion unit 152 will be described. The conversion unit 152 uses a conversion table (not illustrated) that defines a relationship between a position and a distance (depth) of a point in the depth image information with three-dimensional coordinates. The conversion table includes a first conversion table for the depth sensor 20a and a second conversion table for the depth sensor 20b.

The conversion unit 152 compares the depth image information that corresponds to the posture identification information “P1” and is generated by the depth sensor 20a with the first conversion table and converts the depth image information into first point group data. The conversion unit 152 compares the depth image information that corresponds to the posture identification information “P1” and is generated by the depth sensor 20b with the second conversion table and converts the depth image information into second point group data. The conversion unit 152 combines the first point group data and the second point group data and generates point group data corresponding to the posture identification information “P1”.

The conversion unit 152 repeatedly executes the above processing on depth image information corresponding to other pieces of posture identification information and generates point group data corresponding to the other piece of posture identification information.

The description returns to FIG. 3. The generation unit 153 is a processing unit that compares the point group data with the cylindrical model data 40 and searches for parameters of the cylindrical model data 40 of which the value of the evaluation function of the matching degree reaches the optimum value so as to generate cylindrical model data of the subject. The generation unit 153 associates the searched parameter of the cylindrical model data 40 with the subject identification information and registers the associated information to the cylindrical model data table 142. For example, it is assumed that the subject identification information be input from the input unit 120.

For example, the generation unit 153 searches for the parameter of the cylindrical model data 40 of which the value of the evaluation function reaches the optimum value using an expectation maximization (EM) algorithm. The generation unit 153 acquires the point group data corresponding to the posture identification information “P1” and an initial posture prepared according to the posture identification information “P1”, “P2”, or the like that has been designated in advance in order to acquire the cylindrical model data. It is assumed that a joint portion of each cylinder be preset.

The generation unit 153 compares cylindrical model data 40 of an initial posture with the point group data and calculates a posterior distribution pₙₘ of the point group. The posterior distribution pₙₘ is defined by the formula (1). The reference “n” indicates a point included in point group data, and in a case where nₐ points are included in the point group data, n=1 to nₐ. The reference M indicates each cylinder (part) of the cylindrical model data 40, and in a case where there are 14 parts that are identified by the respective pieces of part identification information Md1 to Md14 as illustrated in FIG. 5, m=1 to 14 (Md1 to Md14).

$$\begin{matrix}[ Expression 1 ] & \\ {P}_{n m} = \frac{exp ( - \frac{{{ɛ}_{m} ( {x}_{n} , θ , 1 )}^{2}}{2 {σ}^{2}} )}{{\sum }_{m = 1}^{M} exp ( - \frac{{{ɛ}_{m} ( {x}_{n} , θ , 1 )}^{2}}{2 {σ}^{2}} )} & ( 1 )\end{matrix}$$

The reference εₘ included in the expression (1) indicates a surface residual and is assumed to be a Gaussian distribution. The surface residual indicates a difference in a vertical direction between a point group and a surface of an m-th cylinder. For example, a first cylinder indicates a cylinder with a part identification number Md1. The surface residual εₘ is specified by xₙ, θ, and I. The reference xₙ indicates three-dimensional coordinates of an n-th point. The reference θ indicates a joint angle (for all joints) between an axis of the m-th cylinder and an axis of an adjacent (for example, m+1-th) cylinder.

The reference I indicates a parameter (length, radius) of the m-th cylinder. The reference σ indicates a variance of three-dimensional coordinates included in the point group data. Note that, the three-dimensional position A and the rotation angle δ of the end of the specific part that are elements other than θ and define the posture are optimized when θ at the three-dimensional coordinates with a sensor reference included in a point group is optimized. Therefore, the three-dimensional position A and the rotation angle δ are not independently considered.

After calculating the posterior distribution pₙₘ, the generation unit 153 calculates a value of an evaluation function Q defined by the expression (2). In the expression (2), the reference P indicates a sum of pₙₘ.

$$\begin{matrix}[ Expression 2 ] & \\ Q ( θ , l , {σ}^{2} ) = \frac{P}{2} [ 1 - 1 nP + 1 n {\sum }_{n = 1}^{N} {\sum }_{m = 1}^{M} {p}_{n m} {{ɛ}_{m} ( {x}_{n} , l , θ )}^{2} ] & ( 2 )\end{matrix}$$

After executing M step 1, the generation unit 153 executes M step 2. M step 1 executed by the generation unit 153 will be described. The generation unit 153 calculates an angle change amount Δθ and adds the angle change amount Δθ to the joint angle θ so as to update the joint angle θ included in the formulas (1) and (2). The generation unit 153 calculates the value of the evaluation function Q from the updated joint angle θ. The generation unit 153 repeatedly executes M step 1 until the value of the evaluation function Q satisfies a predetermined convergence condition. For example, the convergence condition is a condition such that the value of the evaluation function Q is equal to or more than a threshold Th1. In a case where the convergence condition is satisfied, the generation unit 153 proceeds the procedure to M step 2. The threshold Th1 may be appropriately changed.

The generation unit 153 calculates the angle change amount Δθ using the Levenberg-Marquardt (LM) method. For example, the generation unit 153 calculates the angle change amount Δθ on the basis of the expressions (3) and (4). The generation unit 153 may randomly generate the angle change amount Δθ using a method that is not limited to the LM method.

$$\begin{matrix}[ Expression 3 ] & \\ ( {J}_{θ}^{T} {J}_{θ} + λ diag ( {J}_{θ}^{T} {J}_{θ} ) ) Δ θ = - {J}_{θ}^{T} ɛ & ( 3 ) \\ [ Expression 4 ] & \\ {J}_{θ} = \frac{\partial {ɛ}_{n m}}{\partial θ} & ( 4 )\end{matrix}$$

M step 2 executed by the generation unit 153 will be described. The generation unit 153 calculates a body shape change amount ΔI and adds the body shape change amount ΔI to the parameter I so as to update the parameter I included in the expressions (1) and (2). The generation unit 153 calculates the value of the evaluation function Q from the parameter I. The generation unit 153 repeatedly executes M step 2 until the value of the evaluation function Q satisfies a predetermined convergence condition. For example, the convergence condition is a condition such that the value of the evaluation function Q is equal to or more than a threshold Th2. In a case where the convergence condition is satisfied, the generation unit 153 ends M step 2.

The generation unit 153 calculates the body shape change amount ΔI using the LM method. For example, the generation unit 153 calculates the body shape change amount ΔI on the basis of the expressions (5) and (6). The generation unit 153 may randomly generate the body shape change amount ΔI using a method that is not limited to the LM method.

$$\begin{matrix}[ Expression 5 ] & \\ ( {J}_{L}^{T} {J}_{L} + λdiag ( {J}_{L}^{T} {J}_{L} ) ) Δ L = - {J}_{L}^{T} ɛ \\ {J}_{L} = \frac{\partial {ɛ}_{t t m}}{\partial 1} & ( 5 ) \\ [ Expression 6 ] & \\ {J}_{L} = \frac{\partial {ɛ}_{n m}}{\partial l} & ( 6 )\end{matrix}$$

In a case where the M step 2 ends, the generation unit 153 determines whether or not the value of the evaluation function Q satisfies a fitting convergence condition. In a case where the fitting convergence condition is satisfied, the generation unit 153 specifies a parameter that satisfies the fitting convergence condition as the parameter corresponding to the posture identification information “P1”. The fitting convergence condition may be a predetermined threshold or the number of executions of M step 1 or M step 2. In a case where the fitting convergence condition is not satisfied, the generation unit 153 executes M step 1 again.

The generation unit 153 specifies a parameter that satisfies the fitting convergence condition for another piece of the posture identification information of the same subject. In this case, the generation unit 153 may use the parameter of the cylindrical model data that satisfies the fitting convergence condition specified by the previous posture identification information as an initial value of the parameter corresponding to posture identification information this time.

For example, in a case where the generation unit 153 calculates a parameter using the point group data of the posture identification information “P2”, the generation unit 153 may use a parameter that is finally specified using the point group data of the posture identification information “P1” as an initial value. The generation unit 153 can accurately obtain the parameter of the cylindrical model data of the subject using the point group data corresponding to each piece of posture identification information.

The generation unit 153 generates the parameter for each subject by repeatedly executing the above processing for each different subject and registers the generated parameter to the cylindrical model data table 142.

Note that, in the above description, a case has been described where the generation unit 153 calculates the parameter of the cylindrical model data using the point group data for each of the plurality of pieces of posture identification information, for the same subject. However, the present embodiment is not limited to this. The generation unit 153 may calculate the parameter of the cylindrical model data on the basis of point group data corresponding to one piece of posture identification information for the same subject.

The output control unit 154 is a processing unit that controls processing for outputting information of the cylindrical model data table 142 to an external device (not illustrated) that assists competition scoring or training. The output control unit 154 may output the information regarding the cylindrical model data table 142 to the display unit 130 and display the information on the display unit 130.

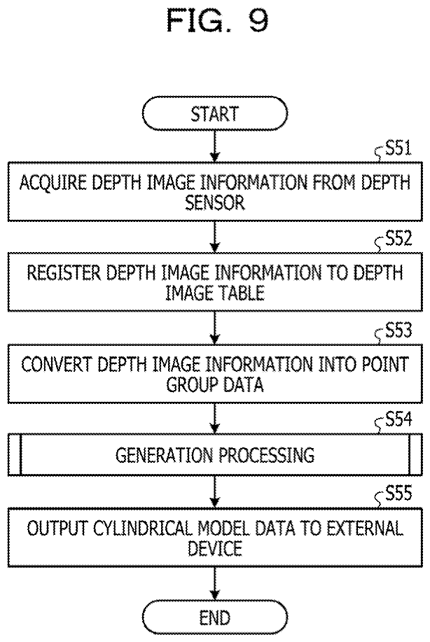

Next, an example of a processing procedure of the information processing apparatus 100 according to the present embodiment will be described. FIG. 9 is a flowchart illustrating a processing procedure of an information processing apparatus according to the present embodiment. As illustrated in FIG. 9, the acquisition unit 151 of the information processing apparatus 100 acquires depth image information from the depth sensor 20 (step S51). The acquisition unit 151 registers the depth image information to the depth image table 141 (step S52).

The conversion unit 152 of the information processing apparatus 100 converts the depth image information into point group data (step S53). The generation unit 153 of the information processing apparatus 100 executes generation processing (step S54). The output control unit 154 of the information processing apparatus 100 outputs cylindrical model data to an external device (step S55).

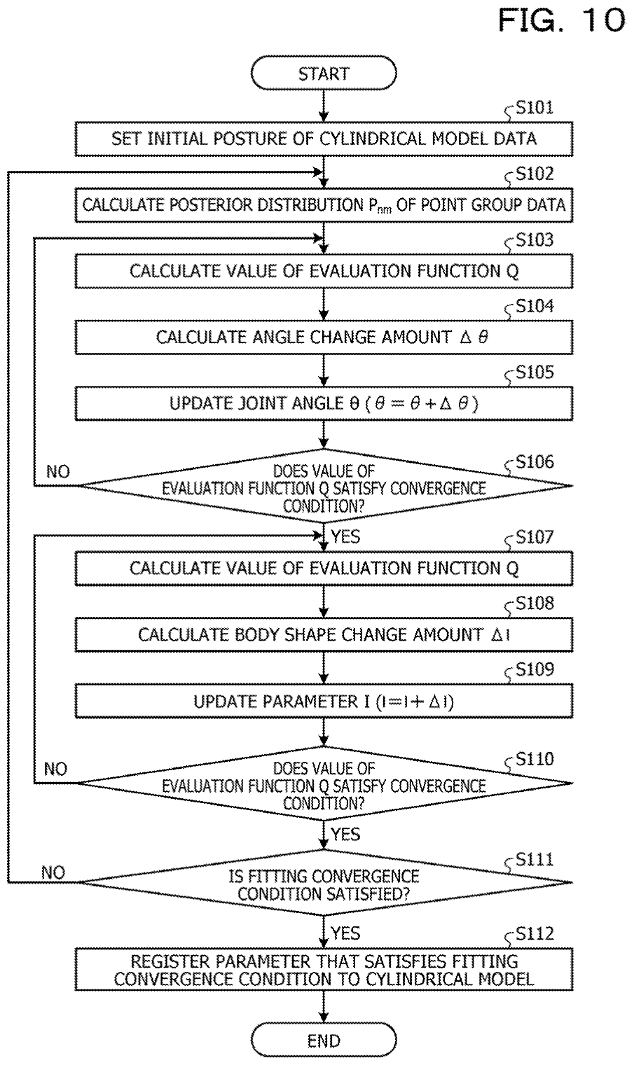

Next, an example of the generation processing indicated in step S54 in FIG. 9 will be described. FIG. 10 is a flowchart of a processing procedure of the generation processing according to the present embodiment. As illustrated in FIG. 10, the generation unit 153 of the information processing apparatus 100 sets an initial posture of the cylindrical model data (step S101). The generation unit 153 calculates a posterior distribution pₙₘ of point group data (step S102). The generation unit 153 calculates a value of an evaluation function Q (step S103).

The generation unit 153 calculates an angle change amount Δθ (step S104). The generation unit 153 updates a joint angle θ (step S105). The generation unit 153 determines whether or not the value of the evaluation function Q satisfies the convergence condition (step S106). In a case where the value of the evaluation function Q does not satisfy the convergence condition (step S106, No), the generation unit 153 proceeds the procedure to step S103.

In a case where the value of the evaluation function Q satisfies the convergence condition (step S106, Yes), the generation unit 153 calculates the value of the evaluation function Q (step S107). The generation unit 153 calculates a body shape change amount ΔI (step S108). The generation unit 153 updates a parameter I (step S109). The generation unit 153 determines whether or not the value of the evaluation function Q satisfies the convergence condition (step S110). In a case where the value of the evaluation function Q does not satisfy the convergence condition (step S110, No), the generation unit 153 proceeds the procedure to step S107.

In a case where the value of the evaluation function Q satisfies the convergence condition (step S110, Yes), the generation unit 153 determines whether or not the fitting convergence condition is satisfied (step S111). In a case where the fitting convergence condition is not satisfied (step S111, No), the generation unit 153 proceeds the procedure to step S102.

On the other hand, in a case where the fitting convergence condition is satisfied (step S111, Yes), the generation unit 153 registers a parameter that satisfies the fitting convergence condition to the cylindrical model data table 142 (step S112).

Next, effects of the information processing apparatus 100 according to the present embodiment will be described. The information processing apparatus 100 calculates the point group data 30 of the subject 5 on the basis of the depth image information acquired from the depth sensor 20. The information processing apparatus 100 generates the parameter of the cylindrical model data corresponding to the subject 5 by executing the processing for searching for the parameter of the cylindrical model data 40 of which the value of the evaluation function reaches the optimum solution on the basis of the point group data 30 and the cylindrical model data 40. In this way, in comparison with the related art in which the depth image of the person is input to a random forest so as to adjust the cylindrical model, the information processing apparatus 100 adjusts the parameter so as to match three-dimensional point group data. Therefore, the parameter (body shape information) of the subject when being expressed by the cylindrical model can be obtained with higher accuracy than before.

The depth image used in the random forest is an image in which depth information is given to a silhouette image of the subject. First, the related art performs part recognition by the random forest on the depth image. As a result, each part in the silhouette of the subject is recognized. In the related art, for each of the plurality of recognized parts, a thickness and a length of each part are determined from the silhouette in the depth image. That is, for example, the thickness and the length are information obtained from the silhouette image in which the subject is two-dimensionally projected. On the other hand, in the present embodiment, from a result of performing optimization so as to minimize a distance between a three-dimensional point group and a model, the thickness and the length of each part are determined. Therefore, the present embodiment can reflect the actual body shape of the subject, not the body shape projected as a silhouette, on the cylindrical model and generate the body shape information.

The information processing apparatus 100 generates the body shape information of the subject using the cylindrical model unlike the body shape information, as the SCAPE model, that defines the body shape to the surface of the human body in detail. Therefore, a calculation cost is reduced, and a more accurate cylindrical model can be generated, as compared with the SCAPE model. Then, the information processing apparatus 100 can perform skeleton recognition at high speed by using the cylindrical model.

In a case where the information processing apparatus 100 specifies a parameter using point group data corresponding to a plurality of pieces of posture identification information for the same subject, the information processing apparatus 100 uses the parameter of the cylindrical model data that satisfies the fitting convergence condition specified by the previous posture identification information as an initial value at the time of calculating the parameter this time. As a result, the parameter can be searched using the point group data corresponding to various postures, and the accuracy of the parameter can be further enhanced.

Note that, the information processing apparatus 100 may specify an average value of the respective parameters of the plurality of different pieces of posture identification information of the same subject as the parameter of the subject.

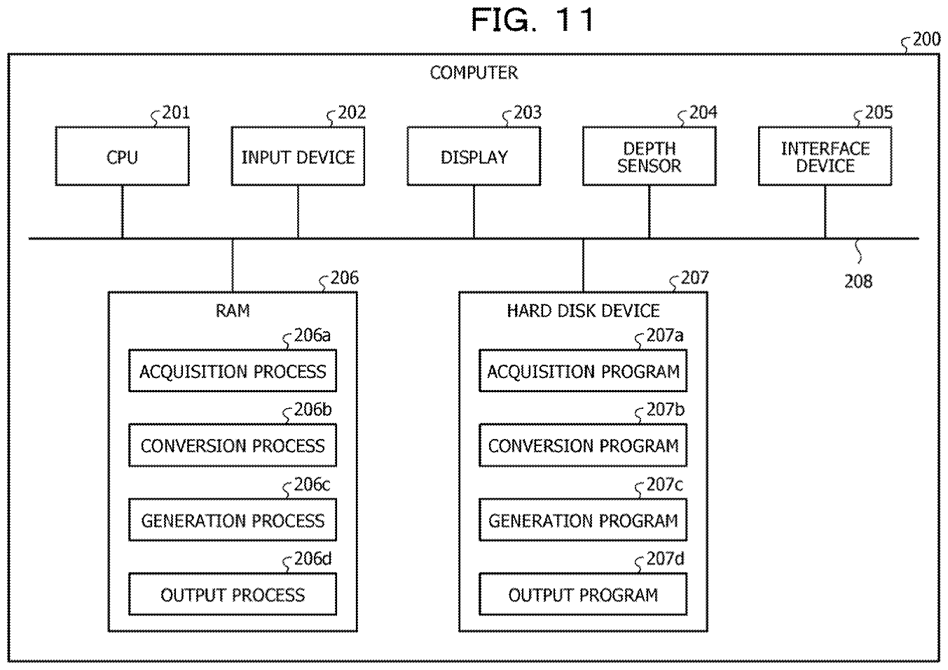

Next, an exemplary hardware structure of a computer that implements functions similar to those of the information processing apparatus 100 described in the embodiment above will be described. FIG. 11 is a diagram illustrating an example of a hardware structure of a computer that implements functions similar to those of the information processing apparatus.

As illustrated in FIG. 11, a computer 200 includes a CPU 201 that executes various types of calculation processing, an input device 202 that receives input of data from a user, and a display 203. Furthermore, the computer 200 includes a depth sensor 204 that generates depth image information and an interface device 205 that exchanges data with an external device via a wired or wireless network. The computer 200 includes a RAM 206 that temporarily stores various types of information, and a hard disk device 207. Then, each of the devices 201 to 207 is coupled to a bus 208.

The hard disk device 207 includes an acquisition program 207a, a conversion program 207b, a generation program 207c, and an output program 207d. The CPU 201 reads the acquisition program 207a, the conversion program 207b, the generation program 207c, and the output program 207d and develops the programs on the RAM 206.

The acquisition program 207a functions as an acquisition process 206a. The conversion program 207b functions as a conversion process 206b. The generation program 207c functions as a generation process 206c. The output program 207d functions as an output process 206d.

Processing of the acquisition process 206a corresponds to the processing of the acquisition unit 151. Processing of the conversion process 206b corresponds to the processing of the conversion unit 152. Processing of the generation process 206c corresponds to the processing of the generation unit 153. Processing of the output process 206d corresponds to the processing of the output control unit 154.

Note that each of the programs 207a to 207d does not need to be stored in the hard disk device 207 beforehand. For example, each of the programs is stored in a “portable physical medium” such as a flexible disk (FD), a compact disc read only memory (CD-ROM), a digital versatile disc (DVD) disk, a magneto-optical disk, or an integrated circuit (IC) card to be inserted in the computer 200. Then, the computer 200 may read and execute each of the programs 207a to 207d.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generation method performed by a computer, the generation method comprising:
acquiring three-dimensional point group data on a surface of a subject from a measurement result of a sensor that obtains three-dimensional position information of the subject;
determining a posture of a cylindrical model that expresses each part of a human body with a plurality of cylinders based on the three-dimensional point group data;
repeatedly executing processing of changing at least one of parameters among parameters for a length of the cylinder, a thickness of the cylinder, and an angle between an axis of the cylinder and an axis of an adjacent cylinder, of the plurality of cylinders and calculating a value of an evaluation function used to evaluate a matching degree between the cylindrical model of which the parameter is changed and the three-dimensional point group data until the value of the evaluation function satisfies a predetermined condition;
generating a cylindrical model including the parameter when the value of the evaluation function satisfies the predetermined condition; and
storing the cylindrical model in association with information used to identify the subject.

2. The generation method according to claim 1, wherein
the predetermined condition indicates that the value of the evaluation function becomes an optimum solution.

3. The generation method according to claim 2, wherein
the generating includes repeatedly executing processing of changing the angle of the plurality of cylinders and calculating the value of the evaluation function used to evaluate a matching degree between the cylindrical model of which the angle is changed and the three-dimensional point group data until the value of the evaluation function becomes a first optimum solution.

4. The generation method according to claim 3, wherein
the generating includes repeatedly executing processing of changing the length of the cylinder and the thickness of the cylinder of the plurality of cylinders after the value of the evaluation function reaches a first optimum solution and calculating a value of an evaluation function used to evaluate a matching degree between the cylindrical model of which the length of the cylinder and the thickness of the cylinder are changed with the three-dimensional point group data until the value of the evaluation function reaches a second optimum solution.

5. The generation method according to claim 1, wherein
the acquiring includes acquiring a plurality of pieces of three-dimensional point group data of different postures of the same subject, and
the generating includes:
specifying a first parameter of which the value of the evaluation function reaches an optimum solution based on first three-dimensional point group data of the plurality of pieces of three-dimensional point group data,
changing the first parameter based on second three-dimensional point group data, and
specifying a second parameter of which the value of the evaluation function reaches an optimum solution so as to generate a cylindrical model.

6. A non-transitory computer-readable storage medium storing a program that causes a processor included in a computer to execute a process, the process comprising:
acquiring three-dimensional point group data on a surface of a subject from a measurement result of a sensor that obtains three-dimensional position information of the subject;
determining a posture of a cylindrical model that expresses each part of a human body with a plurality of cylinders based on the three-dimensional point group data;
repeatedly executing processing of changing at least one of parameters among parameters for a length of the cylinder, a thickness of the cylinder, and an angle between an axis of the cylinder and an axis of an adjacent cylinder, of the plurality of cylinders and calculating a value of an evaluation function used to evaluate a matching degree between the cylindrical model of which the parameter is changed and the three-dimensional point group data until the value of the evaluation function satisfies a predetermined condition;
generating a cylindrical model including the parameter when the value of the evaluation function satisfies the predetermined condition; and
storing the cylindrical model in association with information used to identify the subject.

7. The non-transitory computer-readable storage medium according to claim 6, wherein
the predetermined condition indicates that the value of the evaluation function becomes an optimum solution.

8. The non-transitory computer-readable storage medium according to claim 7, wherein
the generating includes repeatedly executing processing of changing the angle of the plurality of cylinders and calculating the value of the evaluation function used to evaluate a matching degree between the cylindrical model of which the angle is changed and the three-dimensional point group data until the value of the evaluation function becomes a first optimum solution.

9. The non-transitory computer-readable storage medium according to claim 8, wherein
the generating includes repeatedly executing processing of changing the length of the cylinder and the thickness of the cylinder of the plurality of cylinders after the value of the evaluation function reaches a first optimum solution and calculating a value of an evaluation function used to evaluate a matching degree between the cylindrical model of which the length of the cylinder and the thickness of the cylinder are changed with the three-dimensional point group data until the value of the evaluation function reaches a second optimum solution.

10. The non-transitory computer-readable storage medium according to claim 6, wherein
the acquiring includes acquiring a plurality of pieces of three-dimensional point group data of different postures of the same subject, and
the generating includes:
specifying a first parameter of which the value of the evaluation function reaches an optimum solution based on first three-dimensional point group data of the plurality of pieces of three-dimensional point group data,
changing the first parameter based on second three-dimensional point group data, and
specifying a second parameter of which the value of the evaluation function reaches an optimum solution so as to generate a cylindrical model.

11. An information processing apparatus comprising:
a memory; and
a processor coupled to the memory and configured to:
acquire three-dimensional point group data on a surface of a subject from a measurement result of a sensor that obtains three-dimensional position information of the subject;
determine a posture of a cylindrical model that expresses each part of a human body with a plurality of cylinders based on the three-dimensional point group data;
repeatedly execute processing of changing at least one of parameters among parameters for a length of the cylinder, a thickness of the cylinder, and an angle between an axis of the cylinder and an axis of an adjacent cylinder, of the plurality of cylinders and calculating a value of an evaluation function used to evaluate a matching degree between the cylindrical model of which the parameter is changed and the three-dimensional point group data until the value of the evaluation function satisfies a predetermined condition;
generate a cylindrical model including the parameter when the value of the evaluation function satisfies the predetermined condition; and
store the cylindrical model in association with information used to identify the subject into the memory.

12. The information processing apparatus according to claim 11, wherein
the predetermined condition indicates that the value of the evaluation function becomes an optimum solution.

13. The information processing apparatus according to claim 12, wherein
the processor is further configured to repeatedly execute processing of changing the angle of the plurality of cylinders and calculating the value of the evaluation function used to evaluate a matching degree between the cylindrical model of which the angle is changed and the three-dimensional point group data until the value of the evaluation function becomes a first optimum solution.

14. The information processing apparatus according to claim 13, wherein
the processor is further configured to repeatedly execute processing of changing the length of the cylinder and the thickness of the cylinder of the plurality of cylinders after the value of the evaluation function reaches a first optimum solution and calculating a value of an evaluation function used to evaluate a matching degree between the cylindrical model of which the length of the cylinder and the thickness of the cylinder are changed with the three-dimensional point group data until the value of the evaluation function reaches a second optimum solution.

15. The information processing apparatus according to claim 11, wherein
the processor is further configured to:
acquire a plurality of pieces of three-dimensional point group data of different postures of the same subject,
specify a first parameter of which the value of the evaluation function reaches an optimum solution based on first three-dimensional point group data of the plurality of pieces of three-dimensional point group data,
change the first parameter based on second three-dimensional point group data, and
specify a second parameter of which the value of the evaluation function reaches an optimum solution so as to generate a cylindrical model.
